(19) United States
(12) Patent Application Publication
(10) Pub. No.: US 2013/0145664 A1
(43) Pub. Date: Jun. 13, 2013

(54) LABEL FOR INSULATING PACKAGES

(71) Applicant: Noel Mitchell, Wuppertal (DE)

(72) Inventor: Noel Mitchell, Wuppertal (DE)

(73) Assignee: UPM RAFLATAC OY, Tampere (FI)

(21) Appl. No.: 13/701,683

(22) PCT Filed: Jun. 3, 2011
(86) PCT No.: PCT/FI2011/050521

§ 371 Date: Feb. 12, 2013

Related U.S. Application Data
(60) Provisional application No. 61/351,313, filed on Jun. 4, 2010.

(51) Int. Cl. G09F 3/10

(52) U.S. Cl. CPC G09F 3/10
USPC 40/638; 156/87

(57) ABSTRACT

The invention relates to a label for a thermally insulating item which comprises material formed by using a gaseous expansion agent. The label comprises a face material and an adhesive layer, wherein at least one component of the adhesive layer is capable of dealing with the expansion agent escaping from the material of said item. The invention further relates to a labelled thermally insulating item and a method for attaching a label to an item.

### FIELD OF THE INVENTION

The present invention relates to labels. More specifically, the invention relates to self-adhesive labels used in labelling of insulating packages, such as those used in foodservice applications.

### BACKGROUND OF THE INVENTION

Thermally insulating packages are useful for serving items like hot or cold foods and drinks, since the insulative property of such package keeps the item hot or cold for a prolonged period of time after packaging. Polystyrene (PS) foams have good thermal insulation properties and are therefore often used as building insulation materials but also for foodservice packages like beverage cups and food containers or bowls. Polystyrene foams may be either expanded polystyrene (EPS) or extruded polystyrene (XPS). Foam cups or other foodservice packages are produced from expandable polystyrene (EPS). Small beads of PS are impregnated with an expansion agent. The most common blowing agents are volatile organic compounds such as pentane. The final product is formed in a molding process where a hot steam is used to gasify the blowing agent thus expanding the PS beads into the whole volume of the mold. The process may also be carried out under pressure. After molding, the surface of the foam products may be decorated, for example, with identification images, such as a trade name or logo, for retail sales. Post-molding decoration may be performed by using either direct printing or labelling of the product with a printed self-adhesive label. However, there still exists a need for high-quality and more cost-effective labelling of thermally insulating products.

### SUMMARY OF THE INVENTION

It is an object to provide a label, which is easy to attach onto the surface of a thermally insulating package comprising polystyrene foam. It is an object to provide label-decorated insulating packages, for example for foodservice, at a higher overall production rate. These objects can be achieved with label constructions described in the present invention.

According to a first aspect of the present invention, a label for a thermally insulating item is provided, wherein the item comprises a material formed by using a gaseous expansion agent. The label comprises a face material and an adhesive layer, wherein at least one component of the adhesive layer is dealing with the gaseous expansion agent escaping from the material of said item.

According to a second aspect of the present invention, a combination of an item and a label is provided, wherein the label has been attached to a surface of the item comprising a material formed by using a gaseous expansion agent. The label comprises at least one component of the adhesive layer capable to deal with an expansion agent escaping from the material of the item.

According to a third aspect of the present invention, a method attaching a label to an item is provided. The item comprises thermally insulating porous material formed by using gaseous expansion agent. The label comprises a face material and an adhesive layer, wherein at least one component of the adhesive layer is capable of dealing with the gaseous expansion agent escaping from said porous material.

According to fourth aspect of the present invention, a method combining a face material with an adhesive layer is provided. The adhesive layer comprises at least one component capable of dealing with a gaseous expansion agent escaping from a thermally insulating porous material formed by using the gaseous expansion agent

Further embodiments of the invention are presented in the dependent claims.

At least one component of the adhesive layer may be capable of absorbing or allowing penetration of the escaping gaseous expansion agent which is left in the material of the thermally insulating item during the forming process of said item.

At least one component of the adhesive layer may be a hot-melt adhesive comprising rubber or it may be a solvent-based adhesive comprising rubber. The adhesive may comprise a synthetic rubber or it may comprise a block-copolymer rubber. The block-copolymer rubber may comprise styrene.

The face material of the label may comprise at least one of the following: paper, cardboard, plastic film, or foamed polystyrene.

The label may be attached to the surface of a thermally insulating item before stabilization of the item.

The label for a thermally insulating item may also be formed by using a gaseous expansion agent, and the wall thickness of the item may be selected to minimize the amount of expansion agent escaping from the material of the item. The wall thickness of the label may be selected to compensate for at least one of the following: reduced thermal insulation capability or mechanical properties of the item.

The label face material may be foamed polystyrene with a thickness selected from the range between 100 microns and 500 microns.

The label may be a self-adhesive label.

The item may be a package for foodservice, a beverage container or a beverage cup.

The method attaching a label to an item, wherein the item is formed in a mold, a time period between removing the item from the mold and attaching the label to the item may be shorter than 21 days, advantageously shorter than 7 days, preferably shorter than 2 days from the molding of the item.

### DESCRIPTION OF THE DRAWINGS

In the following examples, the embodiments of the invention will be described in more detail with reference to the appended drawings, in which

FIG. 1a shows, in a cross sectional view, a self-adhesive label structure,

FIG. 1b shows, in a cross sectional view, separating a release liner from a label,

FIG. 2 shows, in side view, a label attached to the surface of an item,

FIG. 3a shows, in side view, an evaporation of expansion agents from an item,

FIG. 3b shows, in side view, an adhesive layer adjacent to the item surface.

### DETAILED DESCRIPTION OF THE INVENTION

It has been observed that there are some problems and limitations in the labelling of the products comprising polystyrene foams, such as EPS. Once removed from the mold, the products have a certain period of time during which they will undergo dimensional changes, typically shrinking, and emit blowing agents i.e. gaseous expansion agents used during manufacturing. This is due to the fact that the gaseous expansion agent tends to remain in the product for a prolonged time after the forming process of said item. It may take several weeks for the residual blowing agent to completely escape from the product. If the product is labelled shortly after molding, the escaping gas is blocked by an impermeable, for example acrylic adhesive, and may therefore cause bubbles and creases to form in the labels. Shrinking of the product will cause wrinkling of the label if applied onto the surface of EPS products shortly upon removal from the mold. Thus, labelling of the products immediately after removing from the mold is not possible, which causes a prolonged total production rate of the EPS packages and requires a significant investment in storage capacity to let the products become stabilized. Generally, the products formed using expansion agents are suitable for labelling first after 3 weeks from the molding of the products.

According to the invention, a self-adhesive label is provided for thermally insulating items, such as food service and beverage packages. The thermally insulating item comprises a material which is manufactured by using a gaseous expansion agent, such as pentane. The thermally insulating item may comprise, for example, polystyrene foams, such as EPS. The thermally insulating material may be porous.

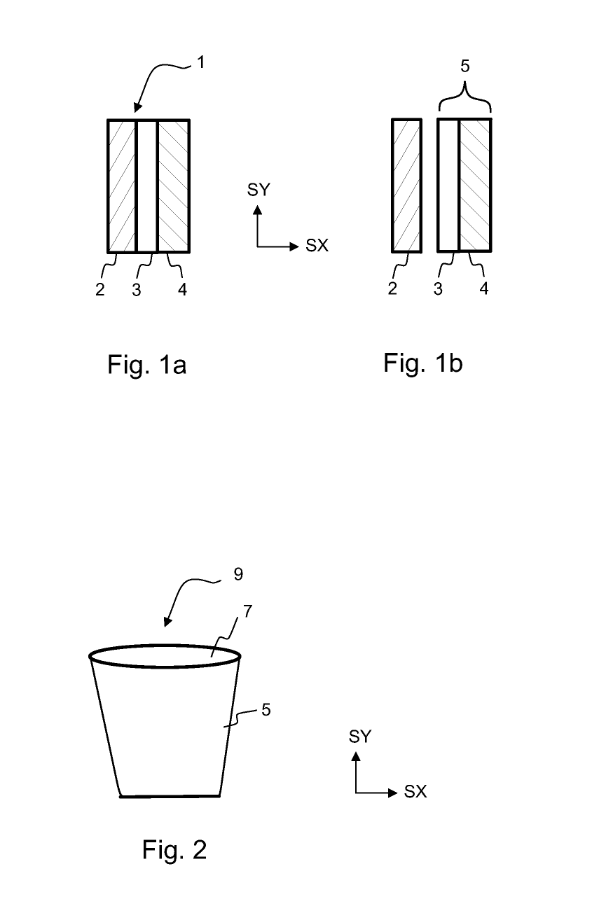

The label may cover substantially the whole exterior surface area of the insulating item. For example, the label may be wrapped around a thermally insulating cup and it may cover the outer wall surface of the cup substantially totally. Alternatively, the label may cover the surface of the item only partially. Self-adhesive labels are also known as pressure sensitive adhesive (PSA) labels or self-stick adhesive labels. Labels may be manufactured by combining a face material with an adhesive layer. Referring to the FIG. 1a, self-adhesive label laminate 1 consists of a release liner 2 and a face material 4 which are laminated together with an adhesive layer 3 in between. The release liner 2 may be coated with a release agent, such as a thin layer of silicone polymer. Referring to FIG. 1b, the label 5 may be separated from the liner 2 by pulling the label in the direction SX with respect to the liner 2. Thus, the surface of the adhesive layer 3 is exposed. FIG. 2 shows a label 5, which is attached to the surface 7 of an item, such as a thermally insulating cup 9. The label 5 may be wrapped around the exterior surface of the cup and it may cover the outer wall surface of the cup substantially totally.

The label face material 4 may comprise a paper sheet, cardboard, plastic film or foamed polystyrene. The face material may be either a monolayer or multilayer structure comprising two or more material layers. Multilayer structures may include layers having the same composition, or the layers may have different compositions. Graphic patterns may be printed on the face material layer 4, in order to provide a visual effect and/or in order to display information. The label may also comprise additional layers, for example sublayers, such as tie layers and protective layers.

The label may be used to provide decoration and/or to display information for thermally insulating items like foodservice and beverage packages, such as cups, containers or bowls. The label may also increase the mechanical strength or dimensional stability of the labelled item. Additionally, the label may also have insulating properties, thus enhancing the insulating capacity of the item.

An adhesive layer may comprise an acrylic based hot-melt adhesive or an acrylic emulsion adhesive. Alternatively, it may comprise a block-copolymer rubber based or synthetic rubber based hot-melt or solvent-based adhesive. The adhesive layer may comprise a monolayer or multilayer structure having same or different adhesive compositions.

The acrylic-based hot-melt adhesives are acrylic polymers and copolymers containing 100% solids, which are melted at high temperatures and coated onto the substrates, either directly on the reverse side of the face material or on the release liner. Such polymers are typically cured by UV radiation. The degree of exposure to UV radiation and curing of the polymers can influence the adhesive properties obtained.

The acrylic emulsion adhesives are acrylic polymers and copolymers which are polymerised in water. These aqueous adhesives are coated onto the substrate, and the water is subsequently evaporated off by passing the coated substrate through a drying tunnel.

Block-copolymer rubber based adhesives are those which typically contain styrene block-copolymers, such as SIS (styrene-isoprene-styrene), SB (styrene-butadiene), SIBS (styrene-isoprene/butadiene-styrene), SEBS (styrene-ethylene/butylene-styrene) and SEPS (styrene-ethylene/propylene-styrene) or mixture of two or more thereof. Such polymers, when mixed with suitable tackifying resins, can be either dissolved in a suitable solvent and then coated onto the substrate and the residual solvent evaporated off, or they could be mixed together at high temperature (approximately 150-200° C.) and then coated onto the substrate as a molten mixture. No further drying or curing is required in the case of molten mixtures. The adhesive layer may also be coated either directly on the reverse side of the face material or on the release liner.

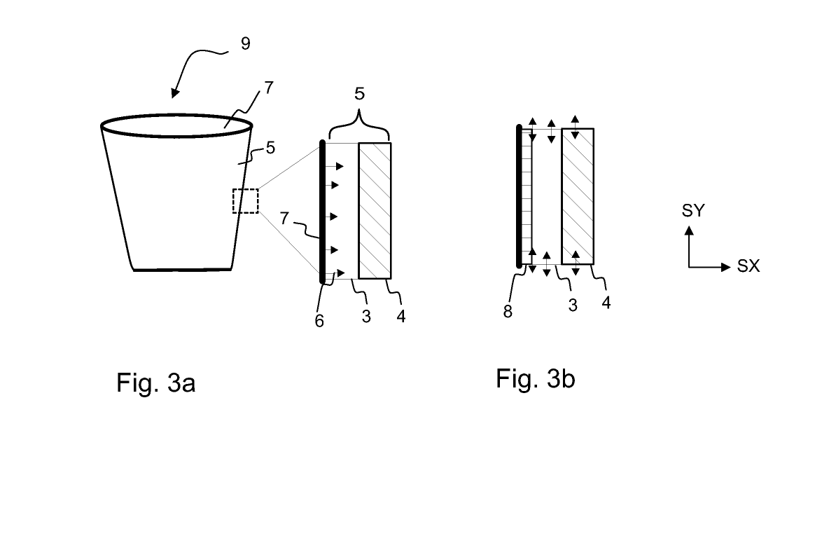

The adhesive layer may appear as an uniform coating or it may have a textured surface comprising separate adhesive areas. The size and/or shape of the adhesive areas may vary. Patterned surface of the adhesive layer may allow gas evaporation from the item surface and penetration through an adhesive layer without causing bubbles or creases to form in the label. FIG. 3a shows an illustrative view of the labelled item 9, wherein the gas evaporates from the item surface 7 into the adhesive layer. The label 5 comprises an adhesive layer 3 which capable of absorbing the organic expansion agent 6 escaping from the polystyrene foam product. Absorption is possible when the escaping expansion agent, such as pentane, is a solvent for the polymer and/or resin contained in the adhesive. In other words, the adhesive can be dissolved by the expansion agent to at least some extent. Alternatively, the adhesive layer may comprise one or more fillers, additives or auxiliary agents capable of absorbing releasing expansion agents, dissolving in the expansion agent, or preventing blocking of the evaporating gas into the adhesive layer.

The basic and the most important aspect according to the invention is that the adhesive layer is capable of dealing with the escaping gas so that the gas will not push the adhesive and the face material off the foam product, i.e. the formation of bubbles and/or creases of the label may be reduced or preferably avoided. The expression dealing may also mean interacting, reacting, handling and/or treating. This feature can be based on absorption, dissolution, penetration or a combination thereof of the expansion agent evaporating from the thermally insulating item by means of at least one component of the adhesive layer. Therefore, when this kind of a label is applied onto the surface of the product made of polystyrene foam, such as EPS, the escaping expansion agent, such as pentane, is dealt with by the adhesive layer, for example is absorbed by the adhesive layer. Pentane may also slightly dissolve the adhesive, causing the adhesive to “swim” on the product surface during the shrinking process of the product. Thereby the formation of bubbles, creases and wrinkles in the label may be avoided even if the foam product shrinks and/or emits some amount of gases.

An adhesive layer may comprise, for example, a block-copolymer rubber based or synthetic rubber based hot-melt or solvent-based adhesives, such as SIS or SIS/SB based (styrene-isoprene-styrene or styrene-isoprene-styrene/styrene-butadiene) adhesives.

According to the invention, a label construction comprising at least one component of the adhesive layer capable of dealing with gaseous expansion agent escaping from thermally insulating item, such as polystyrene foam product, may enable labelling of the thermally insulating item immediately or shortly after molding when there still exists releasing of expansion agents and/or dimensional change, such as shrinkage of the product. In other words, it is possible to attach the label to the surface of the thermally insulating item before stabilization of the item; i.e. there is no need for intermediate storage of the item before labelling. The labelling may be possible in less than three weeks, or in 1 week, or in a few days from the molding of the product.

FIG. 3b shows that due to the gas absorbing nature and slight dissolving of the adhesive layer at least at the interface 8 of the adhesive layer adjacent to the item surface, the adhesion of the adhesive to the surface of an item may be temporally reduced, which allows the label to conform to the shape of the polystyrene item during a dimensional change, such as the shrinking process of the product.

In the case of an adhesive layer capable of absorbing the escaping expansion agent, the face material is preferably paper or other gas permeable material which may further allow some amount of the gas to penetrate through the face material. Depending on the amount of the escaping gas and the thickness of the adhesive layer, it may also be possible to use face materials made of plastic film or other materials, which as such do not allow the gas to penetrate through. Face materials may also be modified in order to enhance the capability of the label to adapt to the dimensional changes of the polystyrene foam product.

According to one embodiment of the invention, the label itself may comprise polystyrene foam, such as foam commercially available under the trademark Styrofoam, as a face material. An insulating label like this can be attached to an insulating polystyrene foam product but also to a product which is made of another non-insulating material, such as paper, plastic or composite. In case of a polystyrene foam product, a block-copolymer rubber based or synthetic rubber based hot-melt or solvent-based adhesive is preferably used so that the above discussed escaping expansion agent may be absorbed by the adhesive. In this case, the label itself has an insulating property as well. The insulating face material of the label allows reducing the wall thickness of the polystyrene foam product and thereby the amount of expansion agent necessary to expand the polystyrene beads and subsequently escaping from the final product may be significantly reduced. This kind of an insulating label may be attached onto the thinner-walled polystyrene foam product surface shortly after removing the product from the mold. The reduced wall thickness of the final product and thereby the reduced mechanical properties, such as impact resistance, and dimensional stability of the product may also be compensated for with the polystyrene foam as a label face material instead of paper. By combining the insulating label with the thinner-walled polystyrene product predetermined mechanical properties and/or predetermined insulating capacity may be achieved. The thickness of the polystyrene label face material may range from approximately 170 to 320 microns, but it can be selected according to the specific application. The thinner-walled polystyrene foam product may also lead to lower production costs, faster cycle times and lower raw material costs.

According to another embodiment of the invention, a label may comprise thick foamed polystyrene as a face material formed by using a gaseous expansion agent. In some example embodiments, the foamed polystyrene face material may have a thickness from 100 to 500 microns and preferably from 170 to 320 microns. The package to be labelled may be general purpose clear or white polystyrene instead of insulating polystyrene foam or any other non-insulating material or material with low thermal insulation capacity. Such general purpose polystyrene products are very low in cost. However, they may have lower mechanical properties such as dimensional stability and poorer insulating properties compared to the other packaging materials presented above. However, a label comprising a foamed polystyrene face material with a thickness of about 300 microns may restore the mechanical properties and dimensional stability and insulation properties of the product. As there are no escaping gases from the final products, an acrylic emulsion adhesive or hot-melt adhesive may be used, and the labels may be applied soon after the manufacturing of the packages.

For a person skilled in the art, it is clear from the description above that the invention is capable of significantly alleviating the problems caused by expandable polystyrene materials in thermally insulating items such as foodservice packages or beverage cups or containers. The gaseous expansion agent necessary in the manufacturing of such materials creates a significant problem in the form of slowly escaping gas and/or dimensional changes of the products. This further requires intermediate storing of the products to let the products become stabilized before high quality labelling of the products becomes viable. The invention provides new possibilities to shorten or to completely eliminate the need for such an intermediate storing and stabilization period and allows the products to be labelled immediately or shortly after the manufacturing.

The above exemplary embodiments describe certain combinations of using an adhesive layer capable of dealing with gaseous expansion agents escaping from the product surface, and/or reducing the wall thickness of the product to be labelled without sacrificing the insulation and/or other properties. The adhesive layer may be capable of absorbing or allowing the penetration of the escaping expansion agent, such as pentane. Use of several different label face materials and structures is possible. It should be clear for a person skilled in the art that the features provided above can be combined according to the teachings of the invention to provide further embodiments of the invention.

The various aspects of the invention are illustrated by the following examples.

### Example 1

A label for a thermally insulating package, said package comprising material formed via use of gaseous expansion agent, said label comprising a label face material and an adhesive, characterized in that the adhesive is capable of absorbing and/or allowing penetration of the gaseous expansion agent escaping from the material of the package.

### Example 2

The label according to example 1, characterized in that the adhesive is soluble by the gaseous expansion agent.

### Example 3

The label according to example 1 or 2, characterized in that the adhesive is a block-copolymer rubber based or synthetic rubber based hot-melt or solvent-based adhesive capable of absorbing and/or allowing penetration of pentane.

### Example 4

The label according to examples 1-3, characterized in that the label face material is a paper.

### Example 5

A labeled thermally insulating package, said package comprising material formed via use of gaseous expansion agent and said label being formed via use of gaseous expansion agent, characterized in that the wall thickness of the package is selected to minimize the amount of expansion agent escaping from the material of the package, and the wall thickness of the label is selected to compensate for at least one of the following: reduced thermal insulation capability or mechanical properties of the package.

### Example 6

A labeled thermally insulating package, said package comprising material with low thermal insulation capability and said label being formed via use of gaseous expansion agent, characterized in that the wall thickness of the label is selected to compensate for at least one of the following: the low thermal insulation capability or mechanical properties of the package.

### Example 7

The labeled thermally insulating package according to examples 5 or 6, characterized in that the label face material is foamed polystyrene with a thickness selected from the range between 100 microns and 500 microns.

### Example 8

The labeled thermally insulating package according to example 6, characterized in that the label face material is foamed polystyrene with an acrylic emulsion adhesive.

### Example 9

The label for any of preceding examples, characterized in that the label is a self-adhesive label.

### Example 10

The package for any of the preceding examples, characterized in that the package is for foodservice, a beverage container or a beverage cup.

For the person skilled in the art, it will be clear that modifications and variations of the devices and methods according to the present invention are perceivable. The drawings are schematic. The particular embodiments described above with reference to the accompanying drawings are illustrative only and not meant to limit the scope of the invention, which is defined by the appended claims.

1. A label for a thermally insulating item comprising material formed by using gaseous expansion agent, said label comprising a face material and an uniform adhesive layer, wherein at least one component of the adhesive layer is configured to absorb the gaseous expansion agent escaping from the material of said item.

2. The label according to claim 1, wherein at least one component of the adhesive layer is dissolvable in the gaseous expansion agent escaping from the material of said item.

3. The label according to claim 1, wherein said at least one component of the adhesive layer is a hot-melt adhesive comprising rubber or solvent-based adhesive comprising rubber.

4. The label according to claim 3, wherein said adhesive comprises synthetic rubber.

5. The label according to claim 3, wherein said adhesive comprises block-copolymer rubber.

6. The label according to claim 5, wherein said block-copolymer rubber comprises styrene.

7. The label according to claim 1, wherein the face material of the label comprises paper and/or cardboard.

8. The label according to claim 1, wherein the face material of the label comprises plastic film and/or foamed polystyrene.

9. A labelled thermally insulating item comprising a material formed by using of gaseous expansion agent and a label comprising a face material and an uniform adhesive layer, wherein the label attached to a surface of the item comprises at least one component of the adhesive layer configured to absorb the gaseous expansion agent escaping from the material of said item.

10. The labelled thermally insulating item according to claim 9, wherein the label is attached to the surface of the item before the stabilization of the item.

11. The labelled thermally insulating item according to claim 9, wherein the label is also formed by using a gaseous expansion agent, and the wall thickness of the item is selected to minimize the amount of expansion agent escaping from the material of the item, and the wall thickness of the label is selected to compensate for at least one of the following: reduced thermal insulation capability or mechanical properties of the item.

12. The labelled thermally insulating item according to claim 11, wherein the label face material is foamed polystyrene with a thickness selected from the range between 100 microns and 500 microns.

13. The label for claim 1, wherein the label is a self-adhesive label.

14. The item for claim 1, wherein the item is a package for foodservice, a beverage container or a beverage cup.

15. A method comprising attaching a label to an item, the item comprising thermally insulating porous material formed by using gaseous expansion agent,
the label comprising a face material and an uniform adhesive layer, wherein at least one component of the adhesive layer is configured to absorb the gaseous expansion agent escaping from said porous material.

16. The method according to claim 15, wherein the item is formed in a mold, a time period between removing the item from the mold and attaching the label to the item is shorter than 21 days, advantageously shorter than 7 days.

17. A method for providing a label, the method comprising combining a face material with an uniform adhesive layer, wherein the adhesive layer comprises at least one component configured to absorb a gaseous expansion agent escaping from a thermally insulating porous material formed by using the gaseous expansion agent.
